(19) United States
(12) Patent Application Publication
(10) Pub. No.: US 2007/0024580 A1
(43) Pub. Date: Feb. 1, 2007

(54) Interactive display device, such as in context-aware environments

(75) Inventors: Ian Michael Sands, Seattle, WA (US); Victor Kevin Russ, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/393,636

(22) Filed: Mar. 30, 2006

Related U.S. Application Data
(60) Provisional application No. 60/703,548, filed on Jul. 29, 2005.

(51) Int. Cl. G09G 5/00

(52) U.S. Cl. 345/156

(57) ABSTRACT

An interactive display facility includes a display component configured to present content so that it is observable by viewers within a vicinity of the display component and a streaming component configured to stream interactive content associated with the presented content to a user device, wherein the interactive content is for presentation to the user in addition to the selected content presented on the display component. The interactive display facility may also include a user detection component configured to detect the presence of a user in a specified vicinity and a content selection component configured to identify content to present to a user detected by the user detection component.

### CROSS-REFERENCE TO RELATED APPLICATION

This application claims priority to U.S. application No. 60/703,548, filed Jul. 29, 2005, entitled “Device/Human Interactions, such as in the Context-Aware Environments,” which is herein incorporated by reference.

### BACKGROUND

Computers and computing devices are finding their way into more and more aspects of daily life. For example, computing devices are found both inside the home (e.g., personal computers, media devices, communication devices, etc.) and outside the home (e.g., bank computers, supermarket checkout computers, computers in retail stores, computer billboards, computing devices relating to providing commercial services, computing devices in cars, etc.). Most of these computing devices have mechanisms that allow them to interact with humans and/or the environment at some level. Aspects of the way that computing devices interact with humans are sometimes referred to as a “user experience.” For example, a human's satisfaction with a computing device interaction (or sequence of computing device interactions) may be based, at least in part, on the richness and/or productivity of the user experience. In addition, various aspects of the environment (including the physical environment) in which the computing device operates to interact with humans may play a role in shaping the user experience.

### SUMMARY

The technology described herein facilitates the electronic presentation of information (e.g., information that is more traditionally associated with posters, brochures, and product signage) to one or more users within an environment. Electronic presentation makes it possible for the information to be presented interactively. The technology includes a display component (e.g., public display screen) that displays or otherwise presents content to users within its vicinity. In addition, aspects of the presented content or additional information related to the presented content can be streamed to a user's personal device (e.g., PDA or smart cell phone). Aspects of the technology may include a user detection component that can be used to detect the presence of a user in a specified vicinity of the display and, optionally, a content selection component that can be used to identify targeted/customized content to present to users.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an environment in which aspects of the interactive display technology can be implemented.

FIG. 2A is a block diagram showing details of a customer identification component of the user presence detection/recognition node of FIG. 1.

FIG. 2B is a block diagram showing details of a customer location tracking component of the user presence detection/recognition node of FIG. 1.

FIG. 3A is a display diagram showing a view of a display provided in accordance with an embodiment of the display technology.

FIG. 3B is a display diagram showing an example of interactive consumable media that allows users to interact with and/or take away content using a personal device.

FIG. 4 is a flow diagram showing a routine at display that allows a user to interact with and/or take away content using a personal device that interacts with the display.

FIG. 5 is a flow diagram showing a routine at user device that allows a user to interact with and/or take away content initially displayed via a display.

FIG. 6 is a flow diagram showing a user identification routine.

### DETAILED DESCRIPTION

Providing a comfortable and aesthetically pleasing environment is important in many contexts, including commercial contexts, civic contexts, educational contexts, etc. For example, in commercial and/or corporate contexts, enhancements in wireless networks and employee mobility may allow customers, clients, and employees to interact in more comfortable lounge-like settings without the need to be tethered to desks or cubicles, while still maintaining communication abilities.

One way to facilitate such an environment is through the use of display technologies, such as streaming interactive media that provides information more traditionally associated with posters, brochures, and product signage. For example, such display technologies can be used to replace posters and large-scale printed graphics in a variety of environments. The display technologies may have interactive aspects. For example, the display technologies can react to changes in the surrounding environment (e.g., the approach of a user) and/or stream to a user's personal device where the user can interact with aspects of the display technologies.

The following description provides specific examples of techniques that can be used in association with one or more computing devices to increase the richness and productivity of user experiences. While the description provides some examples in the context of a bank branch, the techniques described herein are not limited to banking contexts and, rather, can be applied in any type of environment associated with computing devices, including environments associated with other commercial activities besides banking, home environments, environments at sporting events, retail environments, manufacturing environments, workplace environments, customer service environments, entertainment environments, science or research environments, educational environments, transportation environments, etc. Depending on the environment, increasing the richness and productivity of user experiences in accordance with some embodiments may improve customer retention, increase the value of individual customer relationships, reduce costs, result in higher sales, drive sales to new customers, and provide many other personal and/or commercial benefits.

I. Sample Environment

In general, any of the computing devices described herein may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

Embodiments may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

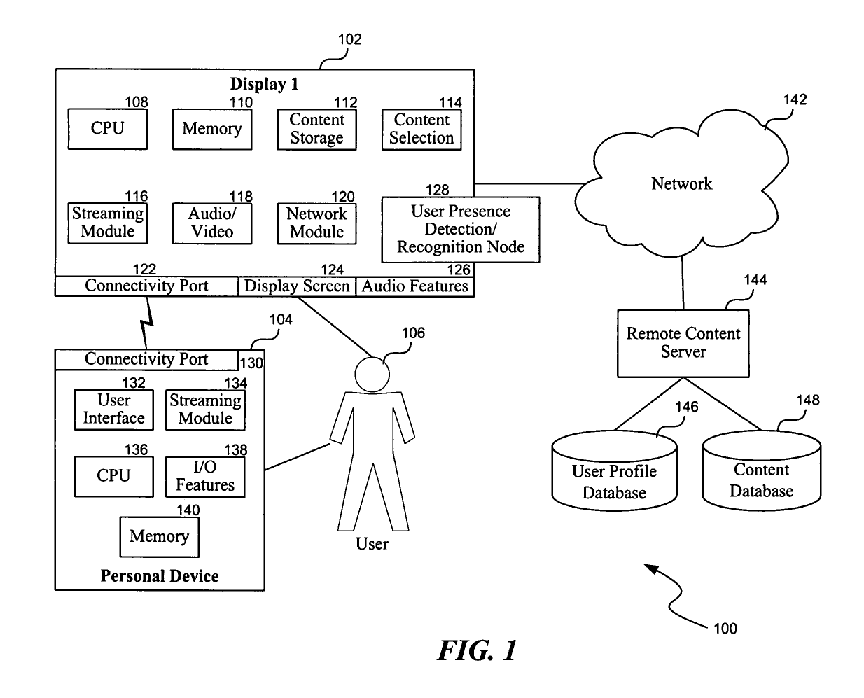

FIG. 1 is a block diagram of a sample environment 100 in which aspects of the interactive display technologies can be implemented. The sample environment 100 includes at least one display 102 and personal device 104 controlled by a user 106. Communication between the display 102 and the personal device 104 is facilitated by data connection, which is most likely a wireless data connection such as infrared, Bluetooth, IEEE 802.11, IEEE 802.11a, IEEE 802.11b, IEEE 802.11g, etc. Another type of connection, however, (e.g., a wired connection or fiber optic connection) may be used.

The display 102 may include a CPU 108 to perform processing, a memory 110, a content storage component 112, a content selection component 114, a streaming module 116, an audio/video component 118, a network module 120, a connectivity port 122, a display screen 124 (e.g., LCD, plasma, projector screen, etc.), and audio features 126. For example, the user 106 may consume presented video content via the display screen and/or audio features and then receive a stream of select content at his or her personal device 104. Accordingly, like the display 102, the personal device 104 may include a connectivity port 130 and a streaming module 134, as well as a user interface 132, a CPU 136, I/O features 138, memory 140, etc.

The display 102 may include and/or communicate with a user presence detection/recognition node 128, which identifies users (known or unknown) and provides information allowing the display 102 to behave in response to the presence of users within its environment. For example, based on information provided by the user presence detection/recognition node 128, the display 102 may wake up from a sleep mode when a user enters into the vicinity of the display 102. Similarly, the display 102 may present information that is specific to a user, based on the identity and/or preferences of the user being known. Various technologies may be used to implement aspects of the user presence detection/recognition node 128.

In some embodiments, the user presence detection/recognition node 128 communicates, e.g., via a network 142, with a remote content server 144 that has access to both a user profile database 146 (which stores user profile information for known users) and a content database 148. Accordingly, based on identifying a known user (e.g., a user having profile information stored in the user profile database 146), the remote content server 144 may serve user-specific content for presentation at the display 102. The user profile database 146 may also store information about a user's response (e.g., favorable, unfavorable, ignored, etc.) to information presented at the display 102. Even if the exact identity of the user is not known, the remote content server 144 may be configured to use information about unknown users to serve specific content. This information may include information about the number of users approaching the display (e.g., whether it is a single user or a group of users, a couple, a family, an adult and a child, etc.), information about the recent past locations of the user or users, etc. For example, if the user presence detection/recognition node 128 detects that a couple is approaching the display 102, the remote content server 144 may use this information to serve display content that is intended for display to a couple (e.g., an advertisement about a vacation to a romantic getaway). Alternatively, if it is likely that a family is approaching, the remote content server 144 may use this information to serve content that is intended for display to a family (e.g., an advertisement about a vacation to Disneyland). In another example, if the user presence detection/recognition node 128 is tracking the location of a user within the environment and can ascertain that the user has performed certain activities based on his or her route through the environment, the remote content server 144 may use this information to serve appropriate content (e.g., if the user just came from a cash machine, the user may be interested in viewing advertisements for financial products).

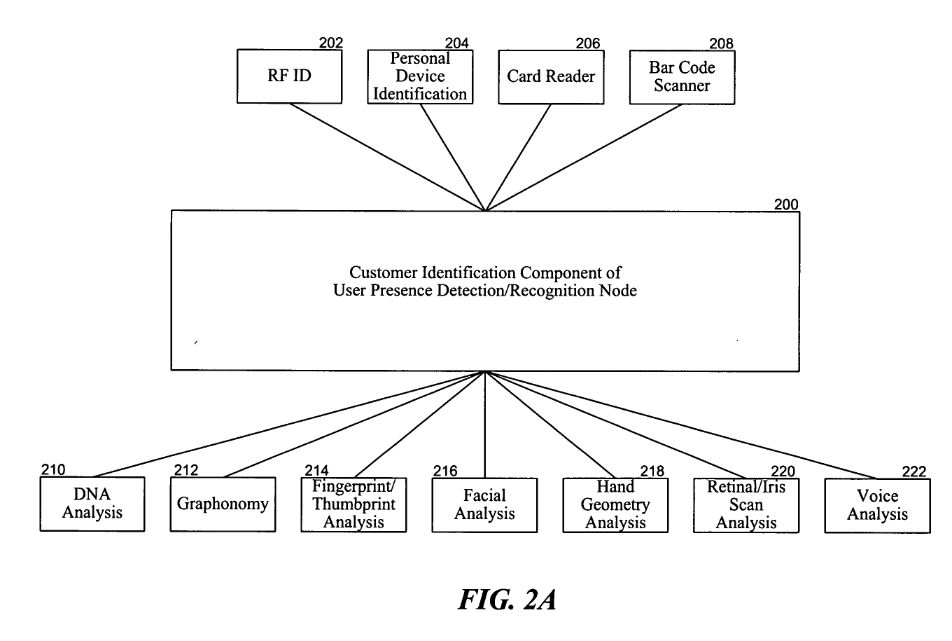

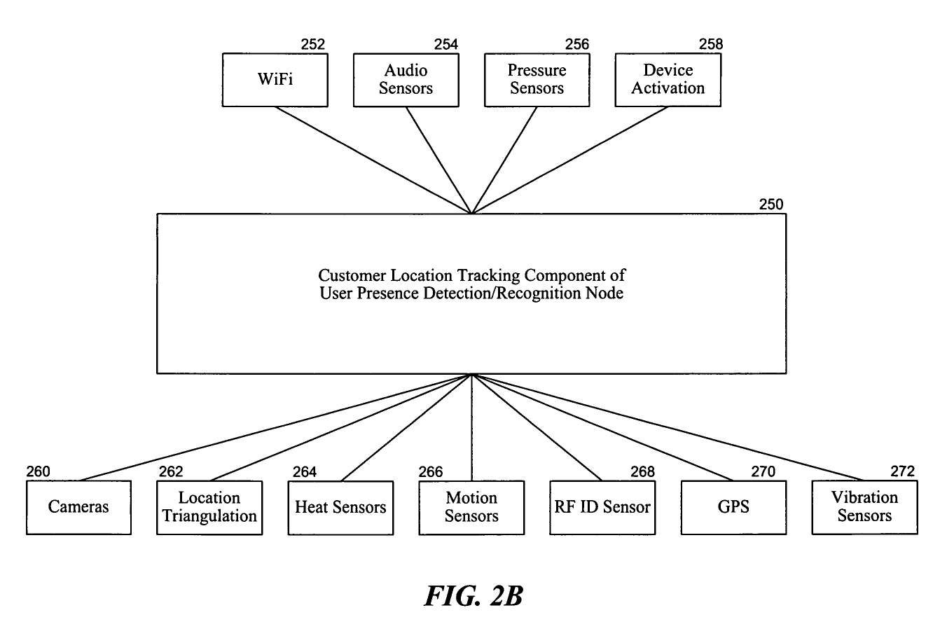

Sample details of the user presence detection/recognition node 128 of FIG. 1 are depicted in FIGS. 2A and 2B. In particular, FIG. 2A is a block diagram showing details of a customer identification component 200 of the user presence detection/recognition node 128, which allows customers to be identified, for example, in a retail setting (e.g., store or bank), and FIG. 2B is a block diagram showing details of a customer location tracking component 250 of the user presence detection/recognition node 128, which allows a customer's location to be tracked, for example, in a retail setting.

In some embodiments, the customer identification component may interface with one or more devices or technologies to allow the interactive display technologies to determine the identity of users (e.g., customers in a retail setting). Examples of such devices/technologies include RF ID 202; personal device identification technologies 204 (e.g., based on unique signal transmitted by personal device); card readers 206 (e.g., configured to read magnetic strips on personal identification cards); bar code scanners 208 (e.g., configured to read bar codes on card or other item); DNA analysis technologies 210 (e.g., configured to determine identity based on available DNA samples from skin, hair, etc.); graphonomy technology 212 (e.g., configured to determine identity based on handwriting or signatures); fingerprint/thumbprint analysis technology 214; facial analysis technology 216; hand geometry analysis technology 218; retinal/iris scan analysis technology 220; voice analysis technology 222; etc.

Many of these technologies/devices function based on having a user register and/or voluntarily provide initial information (e.g., name, biometric information, affiliations, etc.) so that a user profile can be generated. In this way, the user can be identified as soon as the user's presence is subsequently detected within the environment (e.g., by collecting information for each user who enters the environment and then matching this information to find specific user profiles). However, such an initial registration process may not be needed in all cases to generate a user profile. For example, a user profile for an unnamed new user may be initially generated and updated based on collecting available biometric (or other information) for that user, assigning a unique identifier to the user (e.g., an ID number), mapping the unique identifier to the available biometric (or other information), and then subsequently tracking the user's activities within the environment.

Referring to FIG. 2B, the customer location tracking component 250 of the user presence detection/recognition node 128 allows a user's location to be tracked as he or she performs activities and/or moves about an environment (e.g., a retail store, bank, library, hospital, etc.). Examples of some of the location tracking devices and/or technology that the customer location tracking component 250 may employ (either alone or in combination) include WiFi technology 252; audio sensors 254; pressure sensors 256 (e.g., to detect contact with a device or area of the environment); device activation technology 258 (e.g., related to other machine or device in environment, such as ATM, work station, computer, check stand, etc.); cameras 260; location triangulation technology 262 (e.g., image based); heat sensors 264; motion sensors 266; RF ID sensors 268; GPS technology 270; vibration sensors 272; etc.

Tracking the user's location and activities within the environment may further control what type of content is to be selected for display to that user, as well as providing more basic information about when a particular user is approaching a display. For example, if a bank customer is approaching a display after having recently made a large deposit into her savings account using an ATM, it may make sense to display content associated with an offer for a new investment opportunity that the customer may potentially be interested in based on the fact that she recently made the deposit.

II. Sample Display Technologies

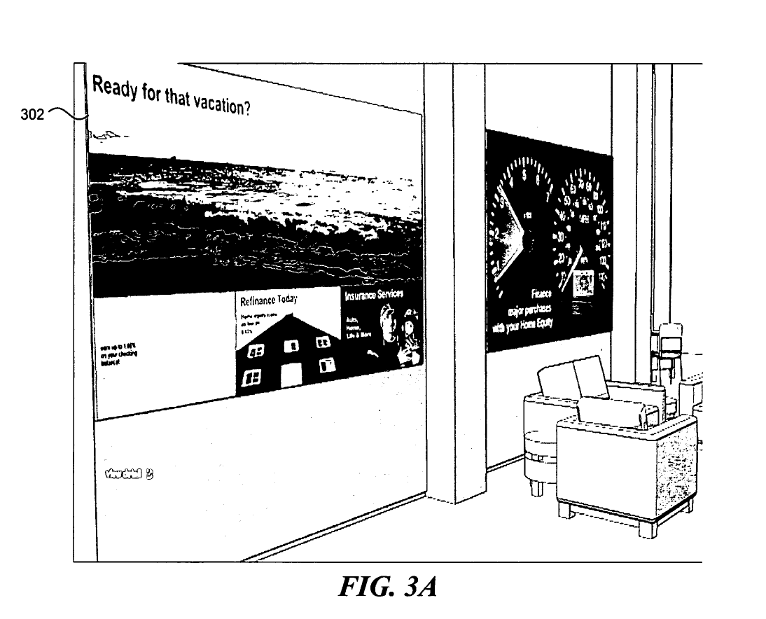

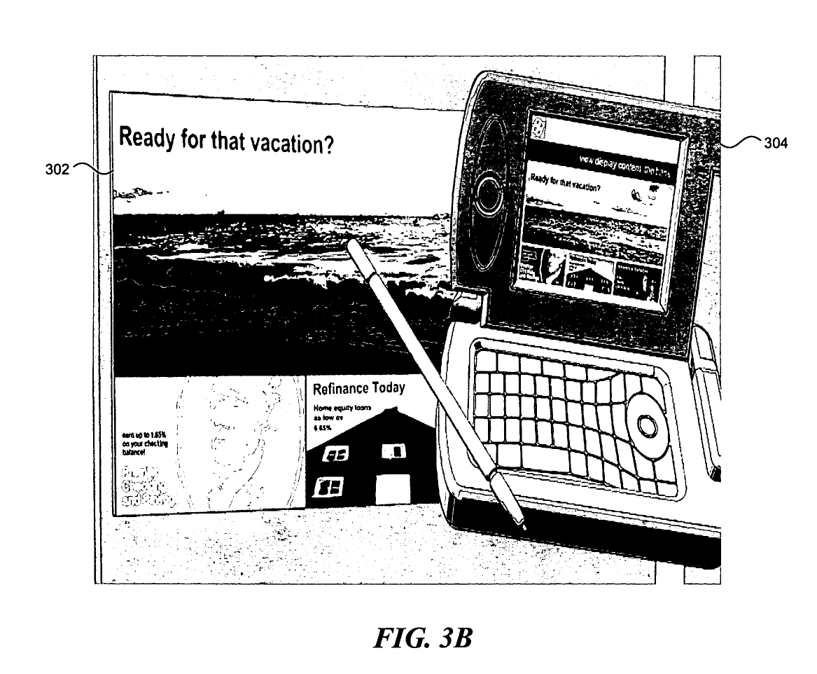

As illustrated in FIGS. 3A and 3B, the display technology allows digital signage solutions to replace static printed media (e.g., traditional posters and signs) to provide enhanced imagery and streaming solutions for product promotions, up-to-the-minute information (e.g., news or financial information), and any other information that customers may be interested in (e.g., public notices, schedules, event information, safety information, alerts, announcements, etc.). FIG. 3A is a display diagram showing a view of a display 302. In some embodiments, the display 302 is interactive at several levels. For example, the display 302 may change as it senses that a customer is getting closer (e.g., by providing more detailed information in smaller print that the customer is now able to read). In this way, information providers (e.g., advertisers or institutions) are able to provide a much richer set of information and services to their customers that can be updated throughout the day, much like a news web site.

In another example, the display 302 is configured so that displayed content streams can be split into multiple channels, allowing users to view content on their own devices and/or take content away with them, much like a take-home brochure, as shown in FIG. 3B. In some cases, the take-away content is automatically streamed to the user's enabled personal device as soon as the user enters the vicinity of the display 302. In other cases, the user actively requests to stream the content to his or her device 304.

In some embodiments, the content streamed to the user device 304 is a subset of the displayed content (e.g., a single user-selected screen). Alternatively, the streamed content is an expanded version of the displayed content, which, for example, allows the user to take home more detailed information than what is initially displayed. For example, a displayed advertisement for a restaurant may, when streamed to the user's device, provide a detailed “menu view.” In another example, the streamed content allows a user to purchase a product or service from his or her personal device and/or learn more details about select products or services. For example, when a user streams information related to the “Ready for that vacation?” advertisement shown on the display 302 to his or her personal device 304, the streamed information may include options to view details about different available vacation packages, select a desired vacation package, and even make reservations using an interface provided in association with the personal device 304.

In addition to allowing the user to interact with aspects of the displayed content (e.g., select from multiple options, play a game, provide personal information, request more information, etc.) at his or her own personal device 304, the display technologies may also facilitate allowing the personal device 304 to provide information back to the display 302 after the user interacts with aspects of the content. For example, the display 302 may stream aspects of a game to be played on the personal device 304. When the user has completed a game, information from the completed game may be exported back to the display 302 so that the display 302 can publicly present the user's score (or other information associated with the user interaction).

As discussed in more detail above with respect to FIG. 1, in some embodiments, the display 302 responds to received profile information for customers in its vicinity and, based on this profile information, provides the most relevant information. For example, banks may use this display technology (along with wireless/wired networks that support real-time content updates) to vary their display-based offerings throughout the day.

Providing interactivity may also involve allowing users to interact with the displays using their own devices (e.g., to leverage multi-cast support). For example, the display may be configured to interact with an application on a user device so that application can, at least to some extent, control the behavior of the display. To illustrate, the user may be able to flip through screens on the display by using controls on his or her mobile device, make selections of options presented on the display, etc.

III. Representative Flows

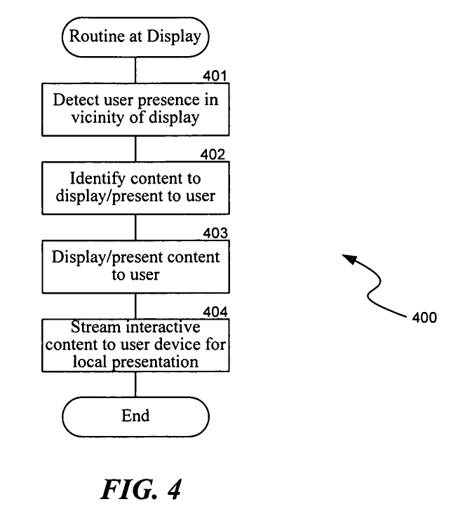

FIGS. 4-6 are representative flow diagrams that show processes that occur within the system of FIG. 1. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. For example, while not described in detail, a message containing data may be transmitted through a message queue, over HTTP, etc. The flows represented in FIGS. 4-6 are high-level flows in which the entire transaction is shown from initiation to completion. The various entities that may be involved in the transaction are also depicted in FIG. 1 and include components of the display 102 and components of the personal device 104, as well as components of the user presence detection/recognition node 138 and remote content server 144.

FIG. 4 is a flow diagram showing a routine 400 performed at display (e.g., such as the display 102 of FIG. 1) that allows a user to interact with and/or take away content using a personal device that interacts with the display. At block 401, the routine 400 detects a user presence in the vicinity of the display. This aspect of the routine 400 may be performed by a user presence detection/recognition node that may be a component of the display or that may be in communication with the display. Details of detecting user presence/identity in the vicinity are described in more detail above with respect to FIG. 1. At block 402, the routine 400 identifies content to present to the user. This content may be stored locally at the display (e.g., in a content queue). Alternatively, the display may query a remote content server for content to display. This query may include information about the user (e.g., information concerning the identity of the user if known, information about the number of users approaching the display as a group, information about the current context of the user approaching the display, information about recent activities performed by the user in an environment, etc.). In response to the query, the remote content server sends appropriate content for display or, alternatively, sends an indication of content stored locally at the display.

At block 403, the routine 400 presents content to the user, which may include audio content, images, movies, or other visual content, or a combination of content using different media. In some embodiments, visual content presentation abilities may be based on display technologies such as those associated with flat panel displays (e.g., liquid crystal displays (LCDs), plasma display panels (PDPs), organic light emitting diodes (OLEDs), field emission displays (FEDs), etc.), active matrix displays, cathode ray tubes (CRTs), vacuum fluorescent displays (VFDs), 3D displays, electronic paper, microdisplays, projection displays, etc.

At block 404, the routine 400 streams content to a device associated with the user. This content may be interactive content (e.g., content that provides user selectable options) or may be static (e.g., purely informational). With interactive content, the user can interact with the content on his or her device, which in turn may (or may not) affect the content on the display. The routine 400 then ends.

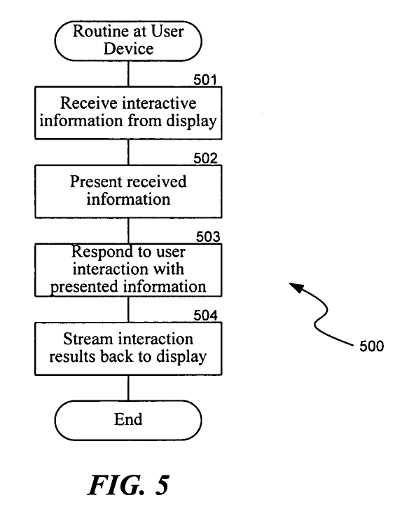

FIG. 5 is a flow diagram showing a routine 500 at user device that allows a user to interact with and/or take away content associated with content initially presented via a display (e.g., a public display). At block 501, the routine 500 receives information from the display (or, alternatively, from a streaming center located in or near the display). In some cases, the receipt of this information is initiated by a user selecting a specific option to receive streaming content from the display. In other cases, the receipt of this information is initiated simply by moving the (compatible) user device within a streaming area/range associated with the display. The stream containing the received information may be continuous (e.g., lasting until the device is removed from the streaming area/range) or intermittent (e.g., a finite transfer of information that occurs as a result of a user action, such as selecting a user option to receive the information or approaching the display).

At block 502, the received information is presented on the user device. For example, the user device may present a small version of an advertisement that was initially presented on the larger display. At block 503, the routine 500 responds to user interaction with the information presented on the user display. For example, in the case of the advertisement, the user may have the option to view details about aspects of the advertisement using the I/O features of the user device. In another example, the user plays a take-away mini game. At block 504, if appropriate, the routine 500 streams interaction results back to the display. For example in the case of the mini game, the user's game results may be streamed back to the display so that they can be presented on the display after the user has completed the game. In another example, the playing of the game itself may be presented on the display so that other patrons in the area can view the game play. The routine 500 then ends.

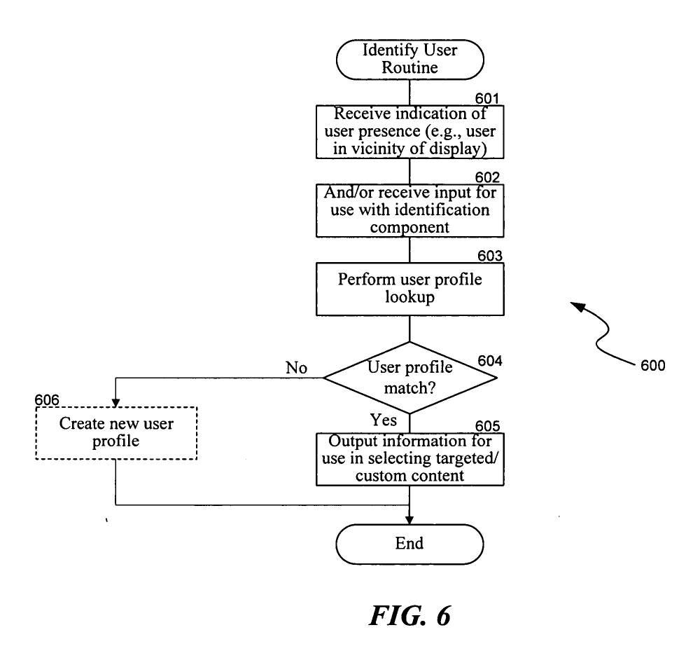

FIG. 6 is a flow diagram showing an example of a routine 600 at a content selection component that facilitates identifying a user e.g., to enable the selection of custom/targeted content for presentation to that user. At block 601, the routine 600 receives an indication of user presence (e.g., an indication that a user has entered the vicinity of the display or, more generally, that a user is present for identification). At block 602, the routine 600 receives input for use in identifying the user (e.g., input collected via the technologies described with respect to FIG. 2A). At block 603, the routine 600 performs a user profile lookup (e.g., database search) based on the received input. At decision block 604, if there is a user profile match, the routine 600 continues at block 605. Otherwise, the routine 600 proceeds to block 606 (create new user profile) or, alternatively, ends. At block 605, the routine 600 outputs information about the user's identity (e.g., for use in selecting targeted/custom content to display to the user). The routine 600 then ends.

From the foregoing, it will be appreciated that specific embodiments have been described herein for purposes of illustration, but that various modifications may be made without deviating from the scope of the invention. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A display interaction system comprising:
a user detection component configured to detect the presence of a user in a specified vicinity;
a content selection component configured to identify content to present to a user detected by the user detection component;
a display component configured to present the identified content to the detected user so that it is observable by viewers within a vicinity of the display component; and
a streaming component configured to stream interactive content associated with the presented content to a user device, wherein the interactive content is for presentation to the user in addition to the selected content presented on the display component.

2. The system of claim 1 wherein the user detection component includes a user identity determination component and a user location tracking component configured to track the user within an environment in which the display component is located.

3. The system of claim 1 wherein the content selection component is located remotely from the display component and is linked to the display component via a network connection.

4. The system of claim 1 wherein the user detection component collects biometric information from users entering a designated area associated with the display component.

5. The system of claim 1 wherein the display component is a wall-mounted display screen in a retail or bank environment.

6. The system of claim 1 wherein the content selection component is configured to identify content that is likely-to be of particular relevance to the user based on collected information relating to the user.

7. A method for providing content for presentation to at least one user, the method comprising:
presenting primary content at a display device configured for displaying content to one or more users in a public area; and
in addition to presenting content at the display device, providing a stream of secondary content to a personal device of at least one of the one or more users, wherein the secondary content is interactive and is related to the primary content.

8. The method of claim 7 wherein the public area is associated with a bank or retailer and wherein the primary content and the secondary content are related to products or services offered in relation to the bank or retailer.

9. The method of claim 7 wherein the secondary content provides detailed information about an offer presented in association with the primary content.

10. The method of claim 7 wherein the primary content is custom-selected for the one or more users based on information collected about the one or more users.

11. The method of claim 7 wherein the primary content is displayed, at least in part, as a result of the one or more users approaching a specified viewing area associated with the display device.

12. The method of claim 7 wherein the secondary content is intended as take-away content that persists, at least temporarily, on the personal device, even after the user has left the public area associated with the display device.

13. The method of claim 7 wherein the public area is a non-commercial environment and wherein the primary content and the secondary content are related to educating users within the non-commercial environment.

14. A method for presenting content to a user of a portable user device, the method comprising:
at the portable user device, receiving a stream of interactive content from a display device configured for presenting content to one or more users in a public area, wherein the interactive content is associated with content presented on the display device;
presenting the received information to the user; and
facilitating interaction between the user and the interactive content.

15. The method of claim 14 further comprising:
sending an indication of the interaction between the user and the interactive content back to the display device.

16. The method of claim 14 wherein the content presented on the display device is content targeted specifically to the user.

17. The method of claim 14 wherein the content presented on the display device is content targeted specifically to the user, and wherein the user's identity is determined after the user enters an environment in which the display device is located.

18. The method of claim 14 wherein the stream of interactive content is received as a result of a specific request by the user.

19. The method of claim 14 wherein the stream of interactive content is received via a wireless communication link.

20. The method of claim 14 wherein the public area is associated with at least one of the following:
a retail environment;
a bank environment;
a workplace environment;
a health services environment;
a transportation environment;
a school or educational environment;
a government facility environment;
a food services environment; or
a sports or entertainment environment.
